(19) United States
(12) Patent Application Publication
(10) Pub. No.: US 2001/0015033 A1
(43) Pub. Date: Aug. 23, 2001

(54) Automatic door-closing device

(76) Inventor: Saburo Minami, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/779,542

(22) Filed: Feb. 9, 2001

(30) Foreign Application Priority Data
Feb. 9, 2000 (JP) 2000-31632
Jan. 9, 2001 (JP) 2001-1010

(51) Int. Cl. E05F 11/00

(52) U.S. Cl. 49/324

(57) ABSTRACT

The present invention, realized for the purpose of providing an automatic door-closing device capable of opening a door and also capable of performing door-closing actions properly and automatically, depending on the weight of the door, etc., without being exposed to outside nor spoiling the appearance of the door, comprises an automatic door-closing mechanism buried in an open upper frame, a guide rail mounted at the top of the door, and a link which moves along the guide rail while turning in pursuance of the opening/closing of the door, serially disposing, in the automatic door-closing mechanism, a power-converting mechanism, connected to one end of the link, for converting the rotating motion of the link due to the opening/closing of the door into a linear motion, an urging mechanism for urging in the door-closing direction, and a buffer mechanism for adjusting the closing speed of the door by controlling the flow rate of the fluid in one direction.

### BACKGROUND OF THE INVENTION

The present invention concerns an automatic door-closing device, more specifically an automatic door-closing device capable of opening a hinged door or a folding door (simply referred to as “door” in some cases in this specification) smoothly, and capable of performing door-closing actions properly and automatically, depending on the weight of the door, etc., without being exposed to outside nor spoiling the appearance of the door.

Conventionally, a hinged door mounted at the entrance of a house or at other entrances is provided with an automatic door-closing device to automatically close an open door.

By the way, a widely used conventional automatic door-closing device is designed in a way to incorporate, in its casing, a spring for urging in the direction closing the door, and a buffer mechanism such as hydraulic damper for adjusting the closing speed of the door, etc.

This automatic door-closing device is usually realized in a way to mount the main body of the automatic door-closing device at the top of the door, and mount the tip of a link provided in projection on the main body of the automatic door-closing device on the fixed side of an open upper frame, etc. (generically called “open upper frame” in this specification).

And, this automatic door-closing device is realized in a way to enable to adjust the closing speed of the door, by adjusting the balance between the urging force of the spring and the flow resistance of the hydraulic operating fluid in the hydraulic damper of the buffer mechanism incorporated in the casing.

By the way, the conventional type of automatic door-closing device, designed in such a way that the main body of the automatic door-closing device is externally mounted at the top of the door as described above, had such problems as not only spoiling the appearance of the door but also increasing the manufacturing cost because the automatic door-closing device must be prepared in many different kinds and colour tones, depending on the material and colour tone, etc. of the door.

### SUMMARY OF THE INVENTION

The objective of the present invention, realized in light of said problems with conventional type automatic door-closing devices, is to provide an automatic door-closing device capable of smoothly opening a hinged door or a folding doo, and capable of performing door-closing actions properly and automatically, depending on the weight of the door, etc., without being exposed to the outside nor spoiling the appearance of the door.

To achieve said objective, the automatic door-closing device according to the present invention is characterized in that it comprises an automatic door-closing mechanism and a guide rail buried in either an open upper frame or at the top of the door, and a link which moves along the guide rail while turning in pursuance of the opening/closing of the door, and that in said automatic door-closing mechanism are serially disposed a power-converting mechanism, connected to one end of said link, for converting the rotating motion of the link due to the opening/closing of the door into a linear motion, an urging mechanism for urging in the door-closing direction, and a buffer mechanism for adjusting the closing speed of the door by controlling the flow rate of the fluid in one direction.

This automatic door-closing device, in the automatic door-closing mechanism of which are serially disposed a power-converting mechanism, connected to one end of said link, for converting the rotating motion of the link due to the opening/closing of the door into a linear motion, an urging mechanism for urging in the door-closing direction, and a buffer mechanism for adjusting the closing speed of the door by controlling the flow rate of the fluid in one direction, makes it possible to form the automatic door-closing mechanism in a slender shape, thereby enabling the burying of the automatic door-closing mechanism in either an open upper frame or at the top of the door, without exposing the automatic door-closing device to the outside including the guide rail and the link.

And, especially because a power-converting mechanism, an urging mechanism and a buffer mechanism are disposed serially in the automatic door-closing mechanism, use of any members with a large capacity for the respective mechanisms does not cause any particular obstacles when burying the automatic door-closing mechanism in either an open upper frame or at the top of the door, and it becomes possible to perform the closing motions of various kinds of doors with different weights, etc. properly and automatically, and to thus provide a highly safe automatic door-closing device.

In this case, it may be all right to dispose the automatic door-closing mechanism at one of the open upper frame or the top of the door, and dispose the guide rail at the other of the open upper frame or the top of the door, respectively.

This will make it possible to easily mount the automatic door-closing device, with no restriction to the mounting position of the automatic door-closing mechanism and even in the case of doors subject to weight restrictions in particular.

Moreover, it may also be all right to dispose the automatic door-closing mechanism at the top of one of the folding doors, and dispose the guide rail at the other folding doors, respectively.

This will make it possible to mount the automatic door-closing device easily, even on folding doors which have not conventionally been provided with automatic door-closing devices.

Furthermore, the power-converting mechanism may be constructed by comprising a pinion turning in pursuance of the rotation of the link due to the opening/closing of the door, and racks engaging with the pinion and converting the rotational motion of the pinion into a linear motion.

This will make it possible to convert the rotation of the link turning in pursuance of the accurate opening/closing of a door into a linear motion by means of a simple mechanism comprised of a pinion and racks, reduce the size of the automatic door-closing device, and improve its working performance.

Still more, by disposing a rack on both sides of the pinion, it becomes possible to convert the rotational motion in one direction of the pinion from a reference position or state of closing the door into a linear motion through the rack on one side, and transfer it to the urging mechanism, and to convert the rotational motion in the other direction of the pinion into a linear motion through the other rack, and transfer it to the urging mechanism.

This will make it possible to perform the closing motion of a door opening in both directions from the reference position or state of closing of the door, properly and automatically.

Yet more, the urging mechanism may be constructed by including a spring adjusting means for adjusting the urging force of the spring urging in the door-closing direction.

This will make it possible to easily adjust the urging force in the door-closing direction, and perform the closing motion of various kinds of doors with different weights, etc. more properly.

In addition, the spring adjusting means may be constructed in such a way that the urging force of the spring can be adjusted with an operation from outside, in the state where the power-converting mechanism is mounted in a door or an open upper frame.

This will make it possible to mount the power-converting mechanism with a reduced urging force of the spring, and then later be adjusted to a proper urging force, and thus perform the mounting of the power-converting mechanism with ease.

### BRIEF DESCRIPTION OF THE DRAWINGS

FIG. 1 indicates the first embodiment of the automatic door-closing device according to the present invention, (A) being a plan view showing the automatic door-closing device in the state where the door is open, and (B) a front sectional view showing the automatic door-closing device in the state where the door is closed.

FIG. 2 indicates the automatic door-closing mechanism, (A) being a front sectional view of the left half, and (B) a front sectional view of the right half.

FIG. 3 indicates the power-converting mechanism, (A) being a plan view, and (B) a front sectional view.

FIG. 4 indicates the pinion, (A) being a plan view, (B) a front elevation, and (C) a bottom view.

FIG. 5 indicates the rack, (A) being a plan view, (B) a bottom view, and (C) a side view.

FIG. 6 indicates the gear pedestal, (A) being a plan view, (B) a partially broken front elevation, and (C) a side view.

FIG. 7 indicates the urging mechanism, (A) being a partially broken front elevation, and (B) a partially broken plan view.

FIG. 8 indicates the spring case, (A) being a front elevation, (B) a side view for above, (C) a plan view, and (D) a side view for above.

FIG. 9 indicates the spring case extension member, (A) being a front elevation, (B) a plan view, (C) a right side view, (D) a left side view, and (E) a front elevation of the cam swingably supported in the case extension member.

FIG. 10 indicates a modified embodiment of the spring case extension member, (A) being a front elevation, (B) a plan view, (C) a right side view, and (D) a left side view.

FIG. 11 indicates the cam in said modified embodiment, (A) being a front elevation, and (B) a sectional view.

FIG. 12 indicates the spring receiving device, (A) being a front elevation, and (B) a side view.

FIG. 13 indicates the spring receiving device, (A) being a front elevation, (B) a plan view, and (C) a side view.

FIG. 14 indicates the spring adjusting member, (A) being a front elevation, and (B) a side view.

FIG. 15 indicates the adjusting ring, (A) being a partially broken front elevation, and (B) a side view.

FIG. 16 indicates the adjusting screw, (A) being a side view, and (B) a front elevation.

FIG. 17 indicates the link, (A) being a plan view, and (B) a sectional view.

FIG. 18 indicates the state where the automatic door-closing device is mounted on a hinged door, (A) being a plan view, and (B) a front elevation.

FIG. 19, indicating the second embodiment of the automatic door-closing device according to the present invention, is a plan view showing the state where the automatic door-closing device is mounted on a folding door.

### DETAILED DESCRIPTION OF THE INVENTION

Embodiments of the automatic door-closing device according to the present invention will be explained based on drawings hereafter.

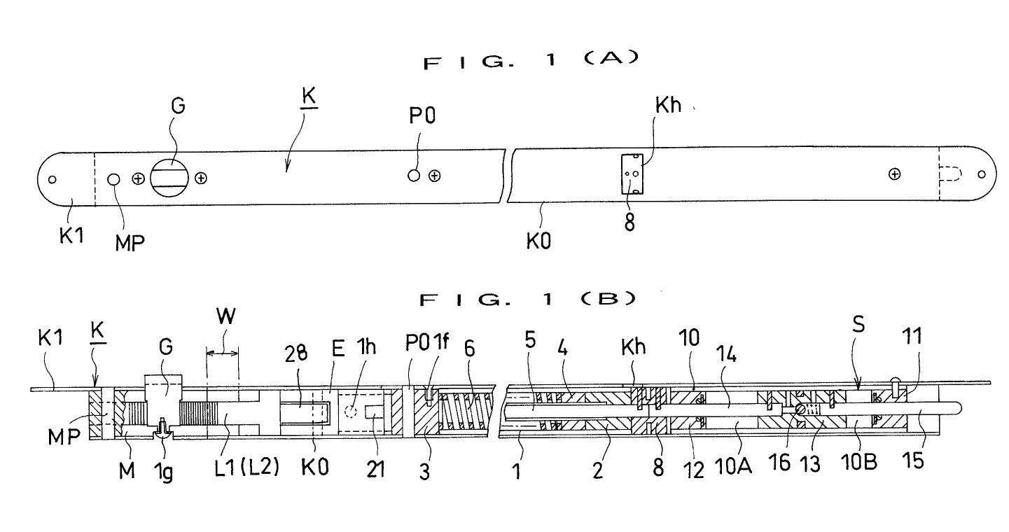

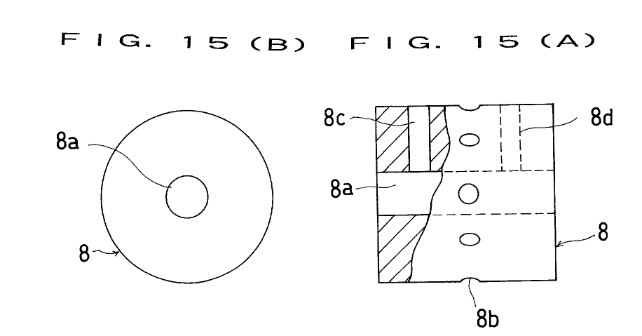

FIG. 1 to FIG. 18 indicate the first embodiments of the automatic door-closing device according to the present invention.

This automatic door-closing device, applied for the purpose of enabling automatic closing of hinged door, is composed of an automatic door-closing mechanism K mounted by burying in an open upper frame F, a guide rail GR mounted at the top of the door D, and a link A provided between the automatic door-closing mechanism K and the guide rail GR and moving along the guide rail GR while turning in pursuance of the opening/closing of the door D.

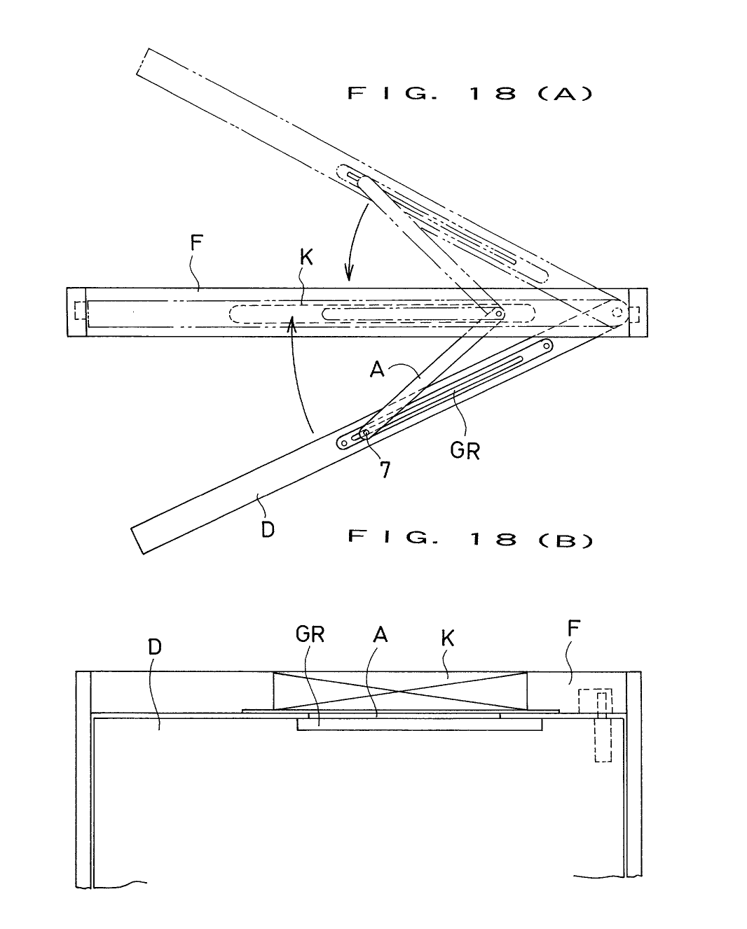

Here, the support of the door D is mounted through a hinge (not illustrated) to a pillar, etc. constituting an open frame, and is constructed to be installed between the automatic door-closing mechanism K and the guide rail GR, so that the link A may be inserted in the gap formed between the door D and the open upper frame F, as shown in FIG. 18, when the door D is closed.

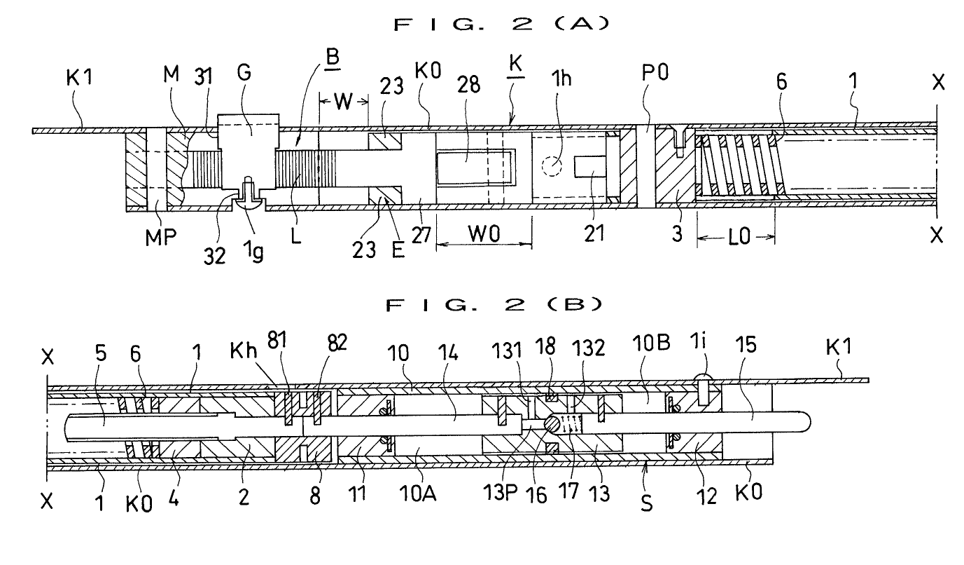

In this case, the automatic door-closing mechanism K of the automatic door-closing device is provided with a slender box-shaped outer case K0 of a length available for mounting by burying in the open upper frame F, with an overall length of approximately 450 to 600 mm, for example, and in this outer case K0 are disposed a power-converting mechanism B, connected to one end of the link A, for converting the rotating motion of the link A due to the opening/closing of the door D into a linear motion, an urging mechanism C for urging in the direction of closing the door D, and a buffer mechanism S for adjusting the closing speed of the door D by controlling the flow rate of the fluid in one direction, as shown in FIG. 1, FIG. 2 and FIG. 18.

The outer case K0, in the shape of a slender box available for mounting by burying in the open upper frame F, will have a lid K1 provided at both ends with a tongue-shaped mounting unit to be buried and screwed in the open upper frame F respectively.

The power-converting mechanism B for converting the rotating motion of the link A due to the opening/closing of the door D into a linear motion will be composed of a pinion G turning in pursuance of the rotation of the link A due to the opening/closing of the door D, and racks L1, L2 engaging with the pinion G and converting the rotational motion of the pinion G into a linear motion, as shown in FIG. 1 to FIG. 6.

This makes it possible to convert the rotation of the link A turning in pursuance of the opening/closing of the door D into a linear motion accurately by means of a simple mechanism composed of the pinion G and the racks L1, L2, reduce the size of the automatic door-closing device, and improve its working performance.

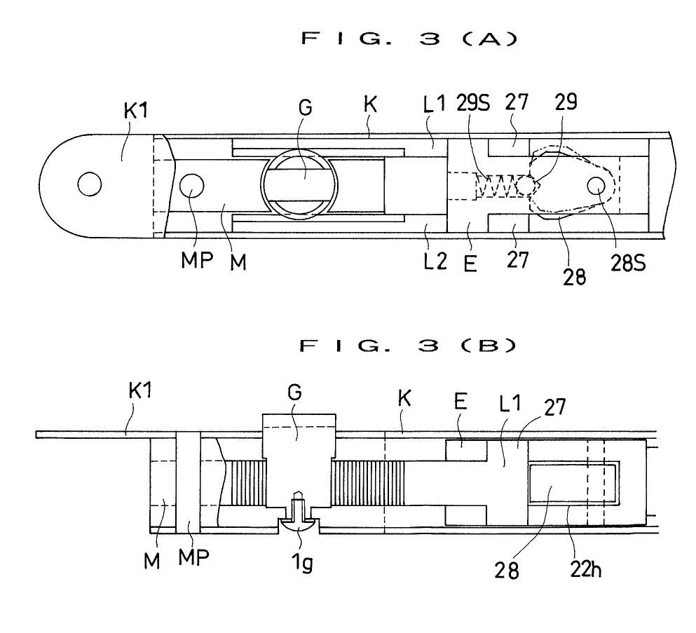

By the way, in this embodiment, the racks L1, L2 are disposed on both sides of the pinion G, as shown in FIG. 3 (A), to make it possible to convert the rotational motion in one direction (left turn) of the pinion G from a reference position or state of closing of the door D into a linear motion (linear motion to the left) through the rack L1 on one side and transfer it to the urging mechanism C, and to convert the rotational motion in the other direction (right turn) of the pinion G into a linear motion (linear motion to the left) through the other rack L2, and transfer it to the urging mechanism C.

While the pinion G makes a rotational motion in one direction (left turn), the other rack L2 makes a linear motion in the opposite direction (to the right) to the rack L1. In the same way, while the pinion G makes a rotational motion in the opposite direction (right turn), the rack L1 on one side makes a linear motion in the opposite direction (to the right) to the rack L2. However, the urging mechanism C is constructed in such a way that no force is transmitted to the urging mechanism C even if the racks L1, L2 make a linear motion to the right, as described later.

This makes it possible to perform closing motion of the door D opening in both directions from this reference position, or state of closing of the door D, as shown in FIG. 18, properly and automatically.

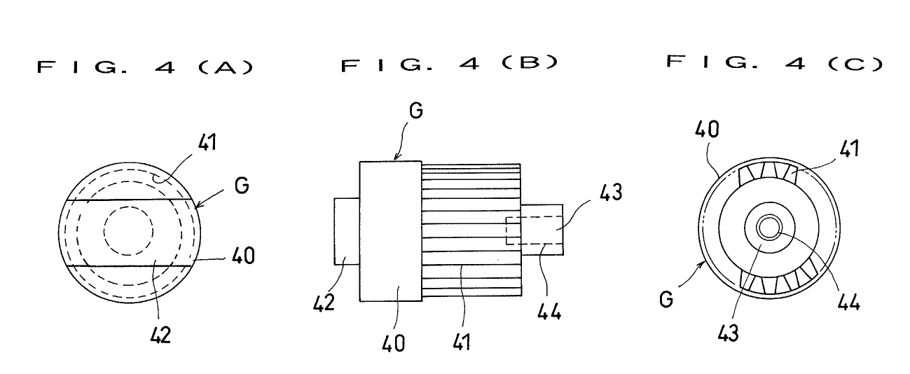

In this case, the pinion G will be constructed by integrally forming a boss 43 having teeth 41, a projection 42 and a threaded hole 44 on the body unit 40 in a short columnar shape, as shown in FIG. 4.

And, a screw 1g will be fastened to the threaded hole 44, so that (the pinion G) may be rotatably supported on a gear base M fixed to the outer case K0 by means of a pin MP.

Moreover, the projection 42 will be fit to a slit a2 formed in the link A, to enable the link A to turn around the pinion G.

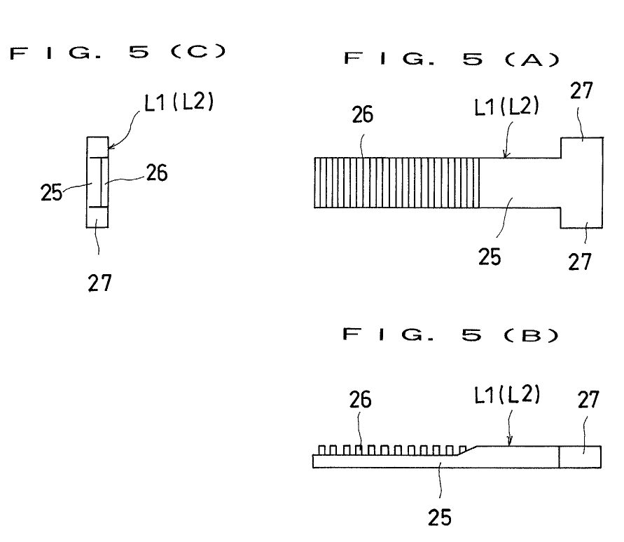

The racks L1, L2 are realized by forming, on one side face of the body unit 25, rack teeth 26 in the longitudinal direction thereof, and also integrally forming fastening claws 27, 27 for fastening with the spring case extension member E of the urging mechanism C, as shown in FIG. 5.

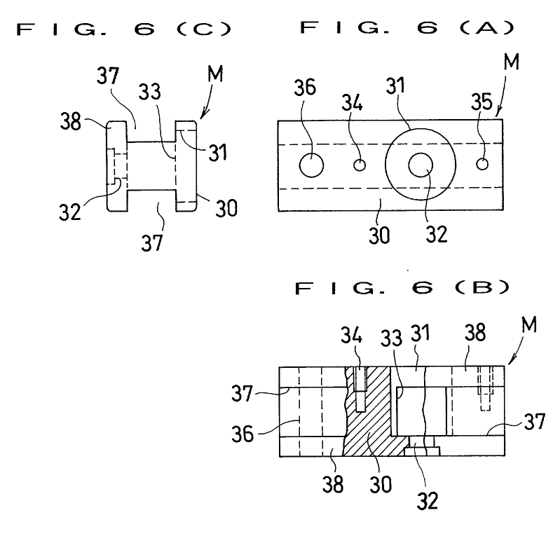

Furthermore, the gear base M fit and screwed to one end position of the outer case K0 forms, on both side faces of the body 30 and over the entire length, rack insertion grooves 37, 37 in which are movably inserted the racks L1, L2, and forms a pinion insertion hole 31 in a way to overlap with these rack insertion grooves 37, 37, as shown in FIG. 6.

This pinion insertion hole 31, which is formed in a diameter enabling insertion of the boss unit 43 of the pinion G in it, forms a window hole 33 in a way to overlap with the rack insertion grooves 37, 37 positioned at the outer circumference of the pinion insertion hole 31, and also forms a hole 32 of small diameter on the side supported by the outer case K0, as shown in FIG. 6 (B).

This makes it possible for the teeth 41 of the pinion G inserted in the pinion insertion hole 31 to protrude into the rack insertion grooves 37, 37, through the window hole 33, and engage with the racks L1, L2.

In the drawing, 34, 35 are mounting holes for screwing the lid K1 of the outer case K0, and 36 represents a pin insertion hole in which to fit the pin MP for fastening the gear base M to the outer case K0.

The urging mechanism C will be realized by movably disposing, in the outer case K0, a spring case 1 assembled by disposing channel-shaped spring case members 1A, 1A in such a way that their open faces face each other, inserting a coil-shaped spring 6 in this spring case 1, and also disposing spring receiving devices 2, 3 in a way to pinch the both ends of this spring 6, as shown in FIG. 1, FIG. 2 and FIG. 7 to FIG. 16.

In above, the spring receiving device 2 on one side will be disposed to be fixed to the spring case 1, and a spring adjusting member 4 will further be disposed, on the spring 6 side of the spring receiving device 2, in a way not to turn in the spring case 1, while to the female thread 4a formed in the spring adjusting member 4 will be fastened an adjusting screw 5 disposed through the spring receiving device 2.

Still more, the other spring receiving device 3 will be disposed to be relatively movable in the spring case 1 by a distance L0 conditioned by the guide hole 1b in the shape of a slit formed in the spring case 1, and fixed to the outer case K0 by means of a pin P0.

In this embodiment, the channel-shaped spring case members 1A, 1A are fixed to the spring receiving device 2 and the spring case extension member E by means of screws 1d, 1e, to be assembled in the shape of a square tube and form the spring case 1.

In this case, for the spring 6, a spring will be used which is capable of accumulating an urging force sufficient for performing the closing motion of the open door D properly and automatically, depending on the weight of the door D, etc.

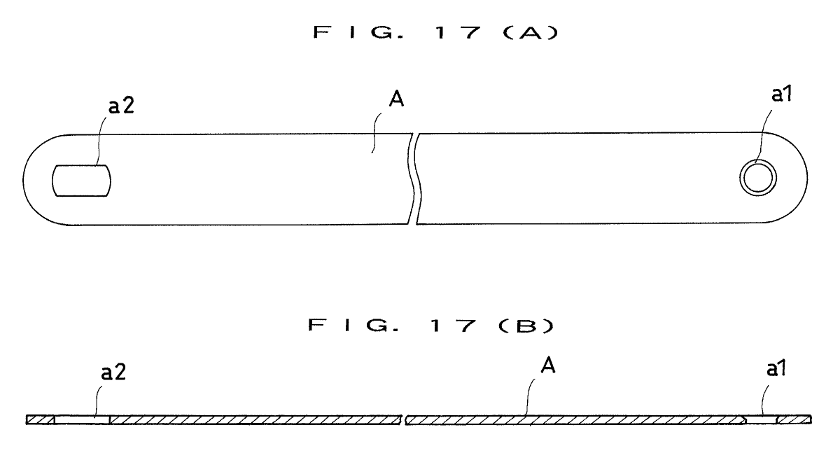

The adjusting screw 5 fastened to the spring adjusting member 4 will have a screw threaded portion 5a to be fastened with the spring adjusting member 4, and a non threaded portion 5b to be freely inserted in the spring receiving device 2, and be realized in a way to be supported for protection against falling, as the base end part of the screw threaded portion 5a gets in contact with the spring receiving device 2, by forming screw threaded portion 5a with a larger diameter compared with the non threaded portion 5b, as shown in FIG. 16.

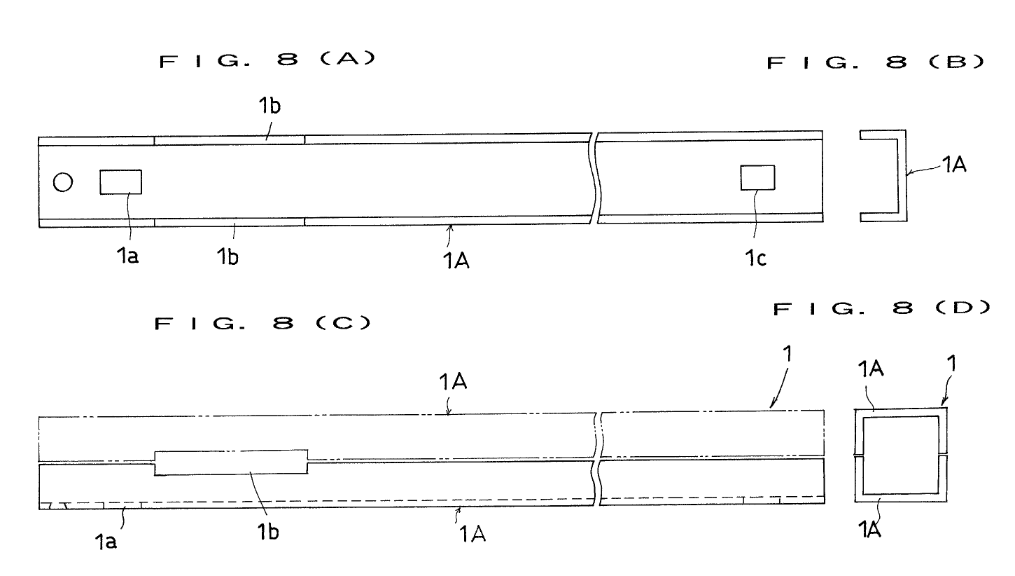

The spring case 1, assembled by disposing channel-shaped spring case members 1A, 1A in such a way that their open faces face each other, will form, as shown in FIG. 8, a fastening hole la for fastening the spring case extension member E, a guide hole 1b in the shape of a slit adjoining this fastening hole 1a and formed along the longitudinal direction of the spring case 1, and a fastening hole 1c for fastening the spring receiving device 2.

And, to the fastening hole 1a will be fit and fastened a fastening claw 21 formed at the end of the spring case extension member E to be inserted in the spring case 1, and to the fastening hole 1c will be fit and fastened a fastening claw 2b formed on the spring receiving device 2 respectively.

Yet more, to the guide hole 1b in the shape of a slit will be fit a projection 3b of the spring receiving device 3 formed in smaller size than the length in longitudinal direction of the guide hole 1b, so that the spring case 1 may be disposed in a way to move by a prescribed distance L0 against the spring receiving device 3 and the outer case K0, to enable the spring 6 inserted in the spring case 1 to be compressed and accumulate an urging force with this movement.

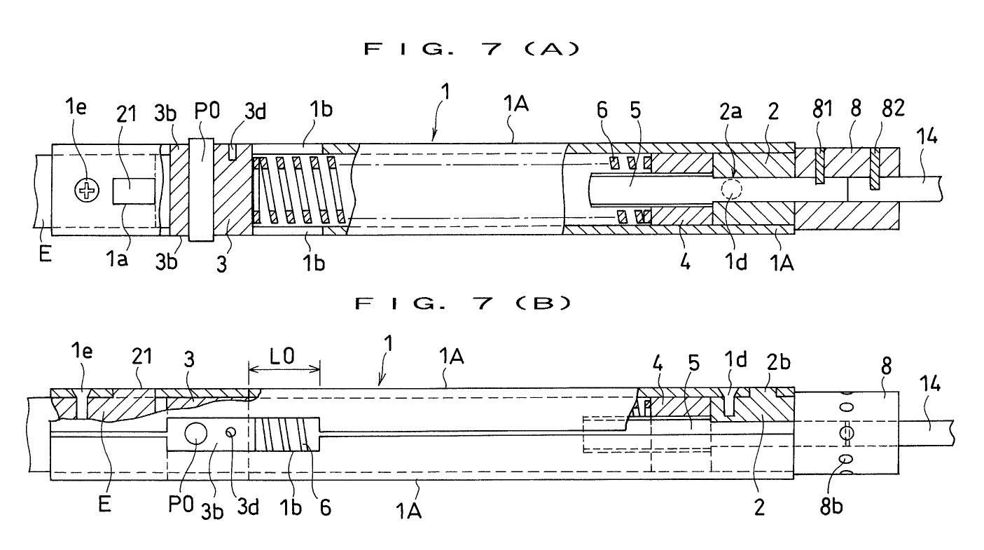

And, to be more concrete, FIG. 2 and FIG. 7 indicate the closed state of the door D, in which the spring 6 is extended and the urging force is released.

On the other hand, when the door D is opened, the spring case 1 will move to the left through the spring case extension member E, and the spring 6 inserted in the spring case 1 will be compressed to accumulate an urging force by getting in contact with the spring receiving device 3.

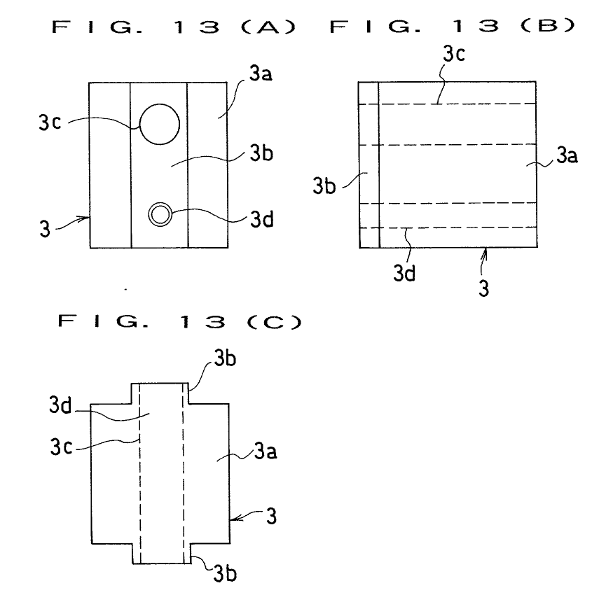

The spring receiving device 2 will have fastening elements 2b, 2b in projection to be fit and fastened to the fastening hole 1c formed in the spring case 1, 1, on both side faces of the body 2a in the shape of a rectangular parallelepiped, and form an insertion hole 2c for inserting the non threaded portion 5b of the adjusting screw 5 at the center and a threaded hole of the screw 1d for fixing the channel-shaped spring case members 1A, 1A at a position near the fastening element 2b, as shown in FIG. 12.

And, the spring receiving device 2 will be fixed at prescribed position in the spring case 1, to support the urging force of the spring 6 transmitted through the spring adjusting member 4 and the adjusting screw 5.

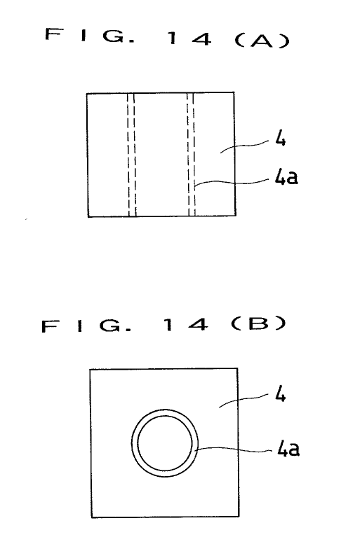

The spring receiving device 3 will form, on the top and bottom faces of the body 3a in the shape of a rectangular parallelepiped, projections 3b, 3b to be fit in the slit-shaped guide hole 1b formed along the longitudinal direction of the spring case 1, and also form a pin insertion hole 3c in which to insert a pin P0 for fixing the spring receiving device 3 to the outer case K0, in a way to pass through both of the projections 3b, 3b including the body 3a, as shown in FIG. 13.

In addition, in the spring receiving device 3 will be formed a thread hole 3d of the screw if for fixing the lid K1 at a position near the pin insertion hole 3c.

To the end part of the non threaded portion 5b of the adjusting screw 5 will be fit an adjusting ring 8, at a position outside the spring receiving device 2, and the adjusting screw 5 and the adjusting ring 8 will be integrated by means of a pin 81, as shown in FIG. 2 and FIG. 7.

And, in the adjusting ring 8 will be inserted a piston rod 14 of the buffer mechanism S coaxially with the non threaded portion 5b of the adjusting screw 5, and integrated by means of a pin 82.

This will make it possible to adjust the urging force of the coil-shaped spring 6 inserted in the spring case 1 by turning the adjusting screw 5 with a rotational operation of the adjusting ring 8, and make the adjusting screw 5 of the urging mechanism C and the piston rod 14 of the buffer mechanism S work in linkage with each other, through the adjusting ring 8.

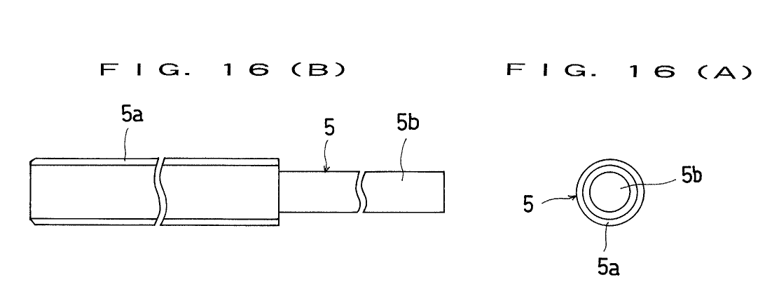

The adjusting ring 8 will form a through insertion hole 8a for inserting the adjusting screw 5 and the piston rod 14, and also form a plurality of depressions 8b for rotational operation on the outer circumferential face, as shown in FIG. 15.

The automatic door-closing mechanism K will be designed in such a way that this depression 8b is positioned at the position of the window hole Kh formed in the lid K1 of the outer case K0, in the state where the door D is opened, as shown in FIG. 1 (A), to enable to make rotating operation easily from outside.

At the end part on the power-converting mechanism B of the spring case 1 will be disposed a spring case extension member E.

This spring case extension member E connects between the spring case 1 of the urging mechanism C and the racks L1, L2 of the power-converting mechanism B. In this case, between the end face of the gear base M and the front face of the fastening element 23 of the spring case extension member E will be formed a gap W, to enable the spring case extension member E to move in linkage with a linear motion of the racks L1, L2 (linear motion to the left in FIG. 3 (A)).

Moreover, as shown in FIG. 3 (A), while the pinion G of the power-converting mechanism B makes a rotational motion in one direction (left turn), the other rack L2 makes a linear motion in the opposite direction (to the right) to the rack L1. In the same way, while the pinion G makes a rotational motion in the opposite direction (right turn), the rack L1 on one side makes a linear motion in the opposite direction (to the right) to the rack L2. However, on the rear face side of the fastening element 23 of the spring case extension member E will be formed a gap W0 allowing free movement of the fastening claw 27 of the racks L1, L2, so that no force may be transmitted to the urging mechanism C even if the racks L1, L2 make a linear motion to the right.

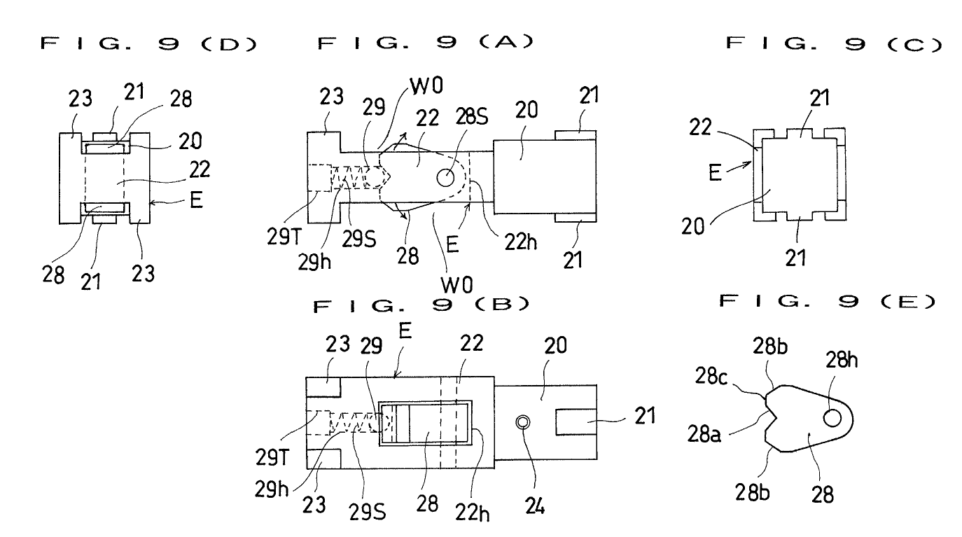

The spring case extension member E will have, on the side face of the base 20, fastening claws 21, 21 in projection to be fit and fastened to the fastening hole 1a formed in the spring case 1, and a body unit 22 on the base 20, and form, on this body unit 22, fastening elements 23, 23 to be fastened with the fastening claw 27 of the racks L1, L2, and further form a cavity 22h in the body unit 22, as shown in FIG. 9, and in this cavity 22h will be swingably disposed a cam 28 indicated in FIG. 9 (E) on the shaft 28S.

And, in the spring case extension member E will be formed a threaded hole 24 of the screw 1h for fixing the spring case extension member E to the spring case 1 at a position near the fastening claw 21, and will also be formed a hole 29h along the longitudinal axial direction of the body unit 22 from the side edge having the fastening element 23.

Furthermore, the cam 28, about in the shape of a heart, will form at one end side a shaft hole 28h for inserting the shaft 28S, form a roughly V-shaped depression 28a at the center of the end face at the other end side, and also form, on both sides of this depression 28a, a fastening end face 28c and a slope 28b leading to the outside face of the cam 28 by inclining from this fastening end face 28c symmetrically to each other.

And, as shown in FIG. 9 (A), the width on the shaft hole 28h side of this cam 28 will be formed smaller than the width of the body unit 22, while, on the other hand, the width on the depression 28a side will be formed larger than the width of the body unit 22, so that the slope 28b may protrude from the body unit 22 into the gap W0 in which the fastening claw 27 of the racks L1, L2 can move freely. In addition, the cam 28 will be disposed in the cavity 22h formed in the body unit 22 so that, when the cam 28 swings around the shaft 28S, as the rack on one side, rack L2 for example, gets in contact with the slope 28b of the cam 28, the fastening end face 28c of the cam 28 may fasten the back face of the fastening claw 27 of the other rack, rack L1 for example, which is fastened with the fastening element 23 of the spring case extension member E.

In the roughly V-shaped depression 28a formed in the cam 28 will be fastened a ball 29 for urging to position the cam 28 at the neutral position.

And, the ball 29 fastened in this depression 28a and the spring 29S for urging the ball 29 will be disposed in the body unit 22, after inserting the ball 29 and the spring 29S in the hole 29h formed in the body unit 22 and sealing them with a plug 29T such as screw, etc.

With this arrangement, when the door D indicated in FIG. 3 (A) is opened from a closed state, the rack L1 on one side will make a linear motion to the left, with the rotational motion in one direction, left turn for example, of the pinion G, and the other rack L2 will make a linear motion to the right.

And, with the linear motion to the right of the rack L2, the rack L2 will get in contact with the slope 28b of the cam 28, the cam 28 will swing around the shaft 28S, and the fastening end face 28c of the cam 28 will fasten the back face of the fastening claw 27 of the rack L1 which is fastened with the fastening element 23 of the spring case extension member E.

This makes it possible to perform closing motion of the door D properly and automatically, with the action of the buffer mechanism S, because the fastening between the fastening element 23 of the spring case extension member E and the fastening claw 27 of the rack L1 is not released, even in case any external force in the direction closing the door D is suddenly applied in the state where the door D is open.

When the door D is closed, the cam 28 will return to the initial neutral position.

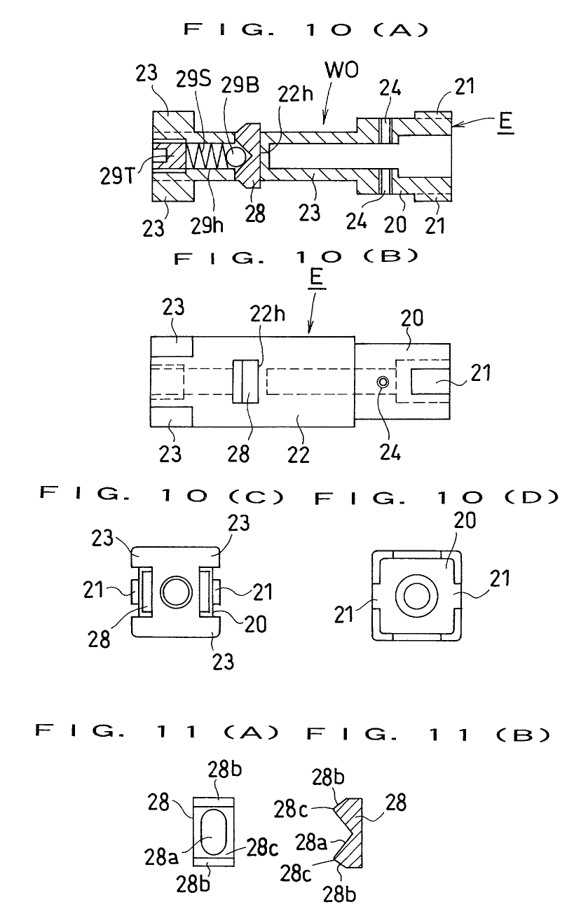

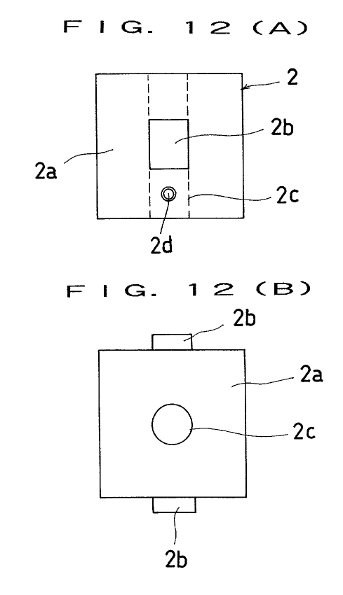

Still more, the spring case extension member E may also be constructed as shown in the modified embodiment indicated in FIG. 10 and FIG. 11.

This spring case extension member E will have, on the side face of the base 20, fastening claws 21, 21 in projection to be fit and fastened to the fastening hole 1a formed in the spring case 1, and a body unit 22 on the base 20, and form, on this body unit 22, fastening elements 23, 23 to be fastened with the fastening claw 27 of the racks L1, L2, and further form a through cavity 22h in the body unit 22 in the direction intercepting the longitudinal axial direction, and in this cavity 22h will be disposed a cam 28K indicated in FIG. 11 slidably in the transversal direction (up-down direction in FIG. 10 (A)).

And, in the spring case extension member E will be formed a threaded hole 24 of the screw 1h for fixing the spring case extension member E to the spring case 1 at a position near the fastening claw 21, and will also be formed a hole 29h along the longitudinal axial direction of the body unit 22 from the side edge having the fastening element 23.

Yet more, the cam 28K, in the shape of a block slidably insertible in the cavity 22h, will form a roughly V-shaped depression 28a at the center of the end face on the side fastening with the racks L1, L2, and also form, on both sides of this depression 28a, a fastening end face 28c and a slope 28b leading to the outside face of the cam 28 by inclining from this fastening end face 28c, symmetrically to each other.

And, it will be so arranged that, when the cam 28K is inserted in the cavity 22h, the slopes 28b, 28b on both sides protrude from the body unit 22 into the gap W0 in which the fastening claw 27 of the racks L1, L2 can move freely. In addition, the cam 28K will be disposed in the cavity 22h formed in the body unit 22 so that, when the cam 28K slides in the transversal direction, as the rack on one side, rack L2 for example, gets in contact with the slope 28b of the cam 28K, the fastening end face 28c of the cam 28K may fasten the back face of the fastening claw 27 of the other rack, rack L1 for example, which is fastened with the fastening element 23 of the spring case extension member E.

In the roughly V-shaped depression 28a formed in the cam 28K will be fastened a ball 29 for urging to position the cam 28 at the neutral position.

And, the ball 29 fastened in this depression 28a and the spring 29S for urging the ball 29 will be disposed in the body unit 22, after inserting the ball 29 and the spring 29S in the hole 29h formed in the body unit 22 and sealing them with a plug 29T such as screw, etc.

With this arrangement, when the door D indicated in FIG. 3 (A) is opened from a closed state, the rack L1 on one side will make a linear motion to the left, with the rotational motion in one direction, left turn for example, of the pinion G, and the other rack L2 will make a linear motion to the right.

And, with the linear motion to the right of the rack L2, the rack L2 will get in contact with the slope 28b of the cam 28K, the cam 28K will slide to the rack L1 side, and the fastening end face 28c of the cam 28K will fasten the back face of the fastening claw 27 of the rack L1 which is fastened with the fastening element 23 of the spring case extension member E.

This makes it possible to perform closing motion of the door D properly and automatically, with the action of the buffer mechanism S, because the fastening between the fastening element 23 of the spring case extension member E and the fastening claw 27 of the rack L1 is not released, even in case any external force in the direction to close the door D is suddenly applied in the state where the door D is open.

Moreover, the cam 28K can move smoothly because it makes a linear sliding motions.

When the door D is closed, the cam 28K will return to the initial neutral position.

The buffer mechanism S for adjusting the closing speed of the door D or, to be more concrete, for slowing down the closing speed of the door D will be constructed by inserting a piston 13 in the cylinder 10 in cylindrical shape to be housed in the outer case K0 and filling the cylinder 10 with hydraulic operating fluid, and this cylinder 10 will be attached to the outer case K0 by means of a screw 1i, as shown in FIG. 2.

The cylinder 10 will be formed in a length enabling the piston 13, inserted in the cylinder 10, to move in pursuance of the opening/closing motions of the door D, while, on the other hand, the piston 13 will be provided with a piston rod 14 to be connected to the adjusting ring 8 of the urging mechanism C and a balance rod 15 to be disposed in projection on the opposite side of this piston rod 14.

The balance rod 15, which is intended to keep constant changes in volume ratio of the bottom side chamber 10A and the head side chamber 10B of the cylinder 10 due to movements of the piston 13, will have the same outside diameter with the piston rod 14.

In this case, in the piston 13 will be formed an oil passage 13P connecting between the bottom side chamber 10A and the head side chamber 10B, and in the oil passage 13P will be disposed a ball valve 16, pressed to the valve seat side at prescribed pressure by means of a spring 17, for opening the oil passage 13P when the door D is opened and closing the oil passage 13P when the door D is closed.

And, in the oil passage 13P will be formed, on both side of the valve seat to which the ball valve 16 is pressed and the sealing member 18 disposed on the outer circumferential face of the piston 13, orifices 131, 132 opening to the outer circumferential face of the piston 13, and the bottom side chamber 10A and the head side chamber 10B of the cylinder 10 will be connected to each other through the orifice 131, the oil passage 13P and the orifice 132.

Moreover, at the end part of the bottom side chamber 10A and the head side chamber 10B of the cylinder 10 will be disposed cylinder plates 11, 12 to seal the cylinder 10, and in these cylinder plates 11, 12 will be inserted the piston rod 14 and the balance rod 15, through a seal for keeping tightness.

In this case, the oil passage 13P and the orifices 131, 132 will be formed in a diameter enabling the hydraulic operating fluid to flow smoothly from the bottom side chamber 10A to the head side chamber 10B of the cylinder 10 without any large resistance, when the door D is opened.

Furthermore, to make it possible for the door D to close at a slow speed even when the ball valve 16 is pressed to the valve seat side and the oil passage 13P is closed, it will be so arranged as to secure prescribed small flow rate of hydraulic operating fluid from the bottom side chamber 10A to the head side chamber 10B of the cylinder 10, by forming a small groove (not illustrated) in the valve seat of the ball valve 16, for example.

The link A, installed between the automatic door-closing mechanism K and the guide rail GR and moving along the guide rail GR while turning in pursuance of opening/closing motions of the door D, will be formed in the shape of a thin plate, as shown in FIG. 17, so that it may be inserted in the gap formed between the door D and the open upper frame F, when the door D is closed, and in the link A will be formed a mounting hole a1 for screwing a moving body 7 which moves along the guide rail GR at one end, and a slit a2 to be engaged with the projection 42 of the pinion G at the other end.

Still more, the guide rail GR will be screwed to the top part of the door D, and its construction will not be restricted in any way, if only it enables the moving body 7 attached to the link A to move smoothly along the guide rail GR.

Next, explanation will be given on actions of this automatic door-closing device.

As shown in FIG. 18, when the door D is opened, the link A installed between the automatic door-closing mechanism K buried in the open upper frame F and the guide rail GR buried at the top part of the door D will turn around the pinion G of the power-converting mechanism B of the automatic door-closing mechanism K, in pursuance of movements of the door D, and the moving body 7 disposed at one end of the link A will move along the guide rail GR.

It will be so arranged that, with a rotation of the link A, the pinion G will turn and the rotational movement of the pinion G will be converted into a linear motion of the racks L1, L2, to transmit a force to the urging mechanism C.

By the way, in this embodiment, the racks L1, L2 are disposed on both sides of the pinion G, as shown in FIG. 3 (A), and this makes it possible to convert the rotational motion in one direction (left turn) of the pinion G from a reference position or state of closing of the door D into a linear motion (linear motion to the left) through the rack L1 on one side and transfer it to the urging mechanism C, and to convert the rotational motion in the other direction (right turn) of the pinion G into a linear motion (linear motion to the left) through the other rack L2, and transfer it to the urging mechanism C.

And, since the racks L1, L2 are connected to the spring case extension member E of the urging mechanism C, the spring case 1 will move in the same direction as the rack L1 or the rack L2, through the spring case extension member E, as the rack L1 or the rack L2 move, and, with this movement, the spring 6 inserted in the spring case 1 will be compressed to accumulate an urging force.

At that time, the oil passage 13P of the buffer mechanism S opens as the ball valve 16 is separated from the valve seat, and this makes it possible for the hydraulic operating fluid to flow from the bottom side chamber 10A to the head side chamber 10B of the cylinder 10 smoothly without being subject to any large resistance, to thus open the door D lightly.

Next, when the force opening the door D is released, a force in the direction closing the door D acts on the door D, because of the urging force (restorative force) accumulated in the spring 6 of the urging mechanism C.

Namely, the spring case 1 moves in the direction opposite to the direction of the previous movement, under the urging force (restorative force) accumulated in the spring 6 of the urging mechanism C.

And, as the spring case 1 moves, either the rack L1 or the rack L2 moves in the same direction as the spring case 1, through the spring case extension member E.

With a movement of the rack L1 or the rack L2, the linear motion of the rack L1 or the rack L2 is converted into rotational motion of the pinion G to turn the pinion G, and, with a rotation of the pinion G, the link A turns in the direction closing the door D, to thus close the door D accurately.

At that time, the oil passage 13P of the buffer mechanism S closes as the ball valve 16 is seated on the valve seat, and this leaves only a small flow rate of the hydraulic operating fluid from the bottom side chamber 10A to the head side chamber 10B of the cylinder 10, to thus close the door D with the flow resistance of this hydraulic operating fluid.

By the way, to adjust the urging force in the direction closing the door D, the adjusting screw 5 will be turned with a rotational operation of the adjusting ring 8, to thereby adjust the urging force of the spring 6 inserted in the spring case 1.

This will make it possible to adjust the urging force in the direction closing the door D and perform closing motion of various kinds of door D with different weights, etc. properly and automatically.

Especially, by arranging in such a way that, as the automatic door-closing device in this embodiment, the depression 8b for rotating the adjusting ring 8 is positioned at the position of the window hole Kh formed in the lid K1 of the outer case K0, in the state where the door D is opened, as shown in FIG. 1 (A), it becomes possible to turn the adjusting ring 8 easily from outside, and this will enable to mount the power-converting mechanism with a reduced urging force of the spring 6, and then adjust to a proper urging force later, and thus perform the mounting of the power-converting mechanism with ease.

This automatic door-closing device can improve the design quality without spoiling the appearance of the door D with the automatic door-closing device, because the automatic door-closing mechanism K, the guide rail GR and the link A constituting the automatic door-closing device are not exposed to the outside of the door D.

Moreover, since the racks L1, L2 are disposed on both sides of the pinion G, to convert the rotational motion in one direction of the pinion G from a reference position or state of closing of the door D into a linear motion through the rack L1 on one side and transfer it to the urging mechanism C, and convert the rotational motion in the other direction of the pinion G into a linear motion through the other rack L2, and transfer it to the urging mechanism C, it becomes possible to perform closing motion of the door D opening in both directions from the reference position or state of closing of the door D, properly and automatically.

For that reason, a single automatic door-closing device can be used for both a door opening to outside and a door opening to inside, and the automatic door-closing device acquires flexibility of application.

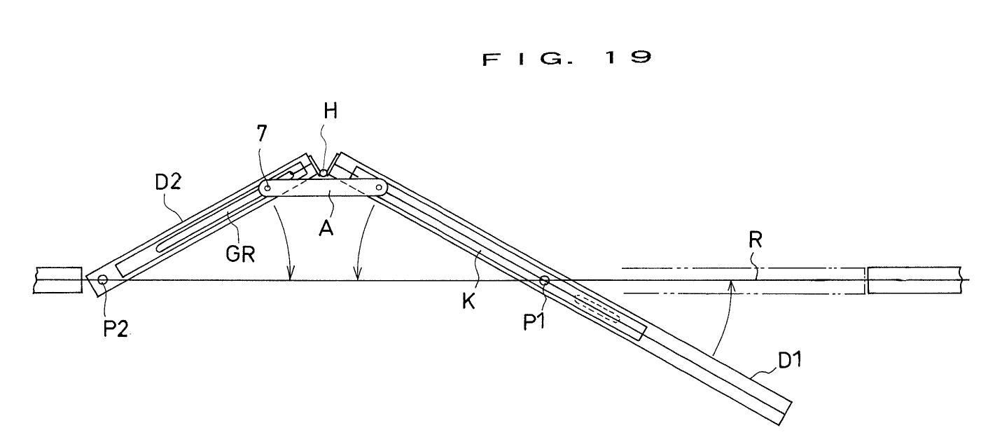

FIG. 19 indicates the second embodiment of the automatic door-closing device a ccording to the present invention.

This automatic door-closing device, applied for the purpose of enabling a folding door to close automatically, is realized by burying an automatic door-closing mechanism K and a guide rail GR at the top of the doors D1, D2 constituting the folding door respectively, and installing, between the automatic door-closing mechanism K and the guide rail GR, a link A moving along the guide rail GR while turning in pursuance of the opening/closing of the doors D1, D2.

In this case, the automatic door-closing mechanism K, the guide rail GR and the link A constituting the automatic door-closing device may be basically the same as those used for the automatic door-closing device of said first embodiment.

The folding door of this embodiment, realized in a way to enable a handicapped person to enter and go out of a toilet and other rooms in the state seated on a wheeled chair, though not particularly restricted to this construction, comprises the door D1 on one side formed in a larger width and the door D2 on the other side in a smaller width, and these two doors D1, D2 are rotatably connected to each other by means of a hinge H, and supported in suspension, through hangers P1, P2, on a rail R disposed on the fixed side such as ceiling, etc.

Next, explanation will be given on actions of this automatic door-closing device.

As shown in FIG. 19, when the doors D1, D2 are opened, the link A installed between the automatic door-closing mechanism K and the guide rail GR turns around the pinion G in the power-converting mechanism B of the automatic door-closing mechanism K in pursuance of movements of the doors D1, D2, and the moving body 7 disposed at an end of the link A moves along the guide rail GR.

With a rotation of the link A, the pinion G turns, and the turning motion of the pinion G is converted into a linear motion of the rack L1 (L2), so as to transmit a force to the urging mechanism C.

And, when the rack L1 (L2) moves, the spring case 1 moves in the same direction as the rack L1 (L2) through the spring case extension member E, because the rack L1 (L2) is connected to the spring case extension member E of the urging mechanism C, and, as a result of this movement, the spring 6 inserted in the spring case 1 is compressed to accumulate an urging force.

At that time, the oil passage 13P of the buffer mechanism S opens as the ball valve 16 is separated from the valve seat, and this makes it possible for the hydraulic operating fluid to flow from the bottom side chamber 10A to the head side chamber 10B of the cylinder 10 smoothly without being subject to any large resistance, to thus open the doors D1, D2 lightly.

Next, when the force opening the doors D1, D2 is released, a force in the direction closing the doors D1, D2 acts on the doors D1, D2, because of the urging force (restorative force) accumulated in the spring 6 of the urging mechanism C.

Namely, the spring case 1 moves in the direction opposite to the direction of the previous movement, under the urging force (restorative force) accumulated in the spring 6 of the urging mechanism C.

And, as the spring case 1 moves, the rack L1 (L2) moves in the same direction as the spring case 1, through the spring case extension member E.

With a movement of the rack L1 (L2), the linear motion of the rack L1 (L2) is converted into rotational motion of the pinion G to turn the pinion G, and, with a rotation of the pinion G, the link A turns in the direction closing the doors D1, D2, to thus close the doors D1, D2 accurately.

At that time, the oil passage 13P of the buffer mechanism S closes as the ball valve 16 is seated on the valve seat, and this leaves only a small flow rate of the hydraulic operating fluid from the bottom side chamber 10A to the head side chamber 10B of the cylinder 10, to thus close the doors D1, D2 with the flow resistance of this hydraulic operating fluid.

Other constructions and actions of the automatic door-closing device of this embodiment are the same as those of the automatic door-closing device of said first embodiment.

The automatic door-closing device according to the present invention has so far been explained based on a plurality of embodiments, but the present invention is not restricted to the constructions described in said embodiments, and its construction can be changed as required as far as it is not deviated from the purpose of the invention.

To be more concrete, while the automatic door-closing mechanism K is mounted in the open upper frame F and the guide rail GR is mounted at the top of the door D respectively in the automatic door-closing device indicated, as shown in FIG. 16, in the first embodiment, for example, it may also be all right to mount the automatic door-closing mechanism K at the top of the door D and mount the guide rail GR in the open upper frame F respectively.

What is claimed is:

1. An automatic door-closing device, characterized in that it is comprised of an automatic door-closing mechanism and a guide rail buried in either an open upper frame or at the top of a door, and a link which moves along the guide rail while turning in pursuance of the opening/closing of the door, and that in said automatic door-closing mechanism are serially disposed a power-converting mechanism, connected to one end of said link, for converting the rotating motion of the link due to the opening/closing of the door into a linear motion, an urging mechanism for urging in the door-closing direction, and a buffer mechanism for adjusting the closing speed of the door by controlling the flow rate of the fluid in one direction.

2. An automatic door-closing device as defined in claim 1, wherein said automatic door-closing mechanism is disposed either in the open upper frame or at the top of the door, and said guide rail is disposed at the other of the open upper frame or the top of the door respectively.

3. An automatic door-closing device as defined in claim 1, wherein said automatic door-closing mechanism is disposed at the top of the door on one side of a folding door, and said guide rail is disposed at the other door of the folding door respectively.

4. An automatic door-closing device as defined in claim 1, wherein said power-converting mechanism comprising a pinion turning in pursuance of rotations of a link due to the opening/closing of the door, and racks engaging with the pinion and converting the rotational motion of the pinion into a linear motion.

5. An automatic door-closing device as defined in claim 4, wherein racks are disposed on both sides of the pinion, to make it possible to convert the rotational motion in one direction of the pinion from a reference position or state of closing of the door into a linear motion through the rack on one side and transfer it to the urging mechanism, and to convert the rotational motion in the other direction of the pinion into a linear motion through the other rack, and transfer it to the urging mechanism.

6. An automatic door-closing device as defined in claim 1, wherein said urging mechanism is comprised of a spring adjusting means for adjusting the urging force of the spring urging in the door-closing direction.

7. An automatic door-closing device as defined in claim 6, wherein said spring adjusting means is constructed in such a way that the urging force of the spring can be adjusted by an operation from outside, in a state where the power-converting mechanism is mounted in a door or an open upper frame.
